(19) United States
(12) Patent Application Publication
(10) Pub. No.: US 2016/0226275 A1
(43) Pub. Date: Aug. 4, 2016

(54) OVERCHARGE PROTECTION APPARATUS FOR BATTERY PACK AND OVERCHARGE PROTECTION SYSTEM

(71) Applicant: SAMSUNG SDI CO., LTD., Yongin-si (KR)

(72) Inventors: Taejin Kim, Yongin-si (KR); Sungsoo Choi, Yongin-si (KR); Seungki Lee, Yongin-si (KR)

(21) Appl. No.: 14/831,832

(22) Filed: Aug. 20, 2015

(30) Foreign Application Priority Data
Jan. 30, 2015 (KR) 10-2015-0015590

(51) Int. Cl. H02J 7/00

(52) U.S. Cl. CPC H02J 7/0029; H02J 2007/0037

(57) ABSTRACT

An overcharge protection apparatus including: a first battery manager to monitor whether or not a battery module including at least one battery cell is overcharged, the first battery manager including a first switch to be turned on when the battery module is overcharged; a second battery manager including a second switch to be turned on by an external cutoff signal; a cutoff switch connected to the first and second battery managers, and to be turned on by the first switch or the second switch; and an overcharge controller to receive a control signal by the cutoff switch, and to generate an internal cutoff signal in response to the control signal.

### CROSS-REFERENCE TO RELATED APPLICATION

This application claims priority to and the benefit of Korean Patent Application No. 10-2015-0015590, filed on Jan. 30, 2015, in the Korean Intellectual Property Office, the disclosure of which is incorporated herein in its entirety by reference.

### BACKGROUND

1. Field

Aspects of one or more exemplary embodiments relate to an overcharge protection apparatus for a battery pack and an overcharge protection system.

2. Description of the Related Art

Much research has been conducted into rechargeable secondary batteries along with the development of portable electronic devices, such as mobile phones, laptop computers, camcorders, and personal digital assistants (PDAs). Particularly, various kinds of secondary batteries, such as nickel-cadmium batteries, lead storage batteries, nickel-hydride batteries, lithium-ion batteries, lithium-polymer batteries, metal lithium batteries, or zinc-air batteries, have been developed.

Such secondary batteries are manufactured in the form of cells, and then the cells are combined with charge/discharge circuits to form battery packs. Thereafter, the battery packs can be charged or discharged by connecting external terminals of the battery packs to external power sources or loads.

A battery pack generally includes battery cells and a peripheral circuit including a charge/discharge circuit. The peripheral circuit is a printed circuit board that is connected to the battery cells. If a component of the printed circuit board of the battery pack catches fire or emits smoke due to abnormal conditions, patterns formed on the printed circuit board may be burnt.

Apparatuses and methods for addressing such situations have been developed and used. Generally, such apparatuses and methods are designed to cut a charge path if a battery cell is overcharged. Such an overcharge protection apparatus including a protection circuit and a battery pack having battery cells may constitute an energy storage system (ESS).

The above information disclosed in this Background section is only for enhancement of understanding of the background of the present invention, and therefore, it may contain information that does not form prior art.

### SUMMARY

One or more exemplary embodiments provide an overcharge protection apparatus for a battery pack and an overcharge protection system that are configured to protect a battery pack or an overall system from an overcharge even when a primary overcharge protection unit operates abnormally.

One or more exemplary embodiments provide an overcharge protection apparatus for a battery pack and an overcharge protection system that are configured to prevent or substantially prevent spreading of damage to the whole system when some of a plurality of energy storage systems connected in series are overcharged.

Additional aspects will be set forth in part in the description which follows and, in part, will be apparent from the description, or may be learned by practice of the presented embodiments.

According to one or more exemplary embodiments, an overcharge protection apparatus includes: a first battery manager configured to monitor whether or not a battery module including at least one battery cell is overcharged, the first battery manager including a first switch configured to be turned on when the battery module is overcharged; a second battery manager including a second switch configured to be turned on by an external cutoff signal; a cutoff switch connected to the first and second battery managers, and configured to be turned on by the first switch or the second switch; and an overcharge controller configured to receive a control signal by the cutoff switch, and to generate an internal cutoff signal in response to the control signal.

The internal cutoff signal may have a voltage level greater than a voltage level of the battery module.

The overcharge controller is configured to generate the internal cutoff signal, and to output the internal cutoff signal to the outside when the cutoff switch is turned on.

The overcharge protection apparatus may further include: an analog front end (AFE) connected in parallel with the first battery manager; and a charge cutoff switch configured to cut off a charge path of the battery module, wherein the first battery manager and the AFE may be configured to turn off the charge cutoff switch when the first battery manager and the AFE determine that the battery module is overcharged.

A voltage level utilized as a reference voltage level by the AFE to determine whether or not the battery module is overcharged may be less than a voltage level utilized as a reference voltage level by the first battery manager to determine whether or not the battery module is overcharged.

The second battery manager may further include a noise filter configured to remove noise from the external cutoff signal, and the second switch may be further configured to be turned on by the external cutoff signal that passed through the noise filter.

The second switch may include a non-contact switch.

The overcharge controller may be configured to output the internal cutoff signal having a constant voltage level in response to the control signal.

The overcharge protection apparatus may further include the battery module including the at least one battery cell.

According to one or more exemplary embodiments, an overcharge protection system includes: a plurality of energy storage systems connected in series, each of the energy storage systems includes: a battery module including at least one battery cell; a first battery manager configured to monitor whether or not the battery module is overcharged, the first battery manager including a first switch configured to be turned on when the battery module is overcharged; a second battery manager including a second switch configured to be turned on by an external cutoff signal input from a previous energy storage system; a cutoff switch connected to the first and second battery managers, and configured to be turned on by the first switch or the second switch; and an overcharge controller configured to receive a control signal by the cutoff switch, and to generate an internal cutoff signal in response to the control signal, wherein the battery modules of the energy storage systems are connected in series.

The internal cutoff signal may have a voltage level greater than a voltage level of the control signal.

The internal cutoff signal may be output to a second battery manager of a next energy storage system.

The overcharge protection system may further include: an analog front end (AFE) connected in parallel with the first battery manager; and a charge cutoff switch configured to cut off a charge path of the battery module, wherein the first battery manager and the AFE may be configured to turn off the charge cutoff switch when the first battery manager and the AFE determine that the battery module is overcharged.

The second battery manager may further include a noise filter configured to remove noise from the external cutoff signal, and the second switch may be configured to be turned on by the external cutoff signal that passed through the noise filter.

The second switch may include a non-contact switch.

The overcharge controller may be configured to output the internal cutoff signal having a constant voltage level in response to the control signal.

The overcharge protection system may further include: a cutoff signal receiver configured to receive an internal cutoff signal from a last energy storage system; and a main switch configured to connect the battery modules to external charge terminals, wherein the cutoff signal receiver may be configured to turn off the main switch when the cutoff signal receiver receives the internal cutoff signal from the last energy storage system.

### BRIEF DESCRIPTION OF THE DRAWINGS

The above and/or other aspects and features will become apparent and more readily appreciated from the following description of the exemplary embodiments, taken in conjunction with the accompanying drawings in which:

FIGS. 1 and 2 are schematic diagrams illustrating an overcharge protection apparatus for a battery pack according to an exemplary embodiment;

FIGS. 3 and 4 are schematic diagrams illustrating an overcharge protection apparatus for a battery pack according to another exemplary embodiment;

FIG. 5 is a schematic diagram illustrating an overcharge protection apparatus for a battery pack according to another exemplary embodiment;

FIG. 6 is a schematic diagram illustrating an overcharge protection system including a plurality of energy storage systems; and

FIG. 7 is a schematic diagram illustrating an overcharge protection system according to an exemplary embodiment.

### DETAILED DESCRIPTION

Reference will now be made in detail to exemplary embodiments, examples of which are illustrated in the accompanying drawings. In this regard, the present invention may be embodied in various different forms and should not be construed as being limited to the embodiments set forth herein. Rather, these embodiments are provided as examples so that this disclosure will be thorough and complete, and will fully convey the aspects and features of the present disclosure to those skilled in the art. Accordingly, the exemplary embodiments are merely described below, by referring to the figures, to explain aspects of the present disclosure. Thus, processes, elements, and techniques that are not necessary to those having ordinary skill in the art for a complete understanding of the aspects and features of the present disclosure may not be described.

In the drawings, the relative sizes of elements, layers, and regions may be exaggerated for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, an overcharge protection apparatus for a battery pack and an overcharge protection system will be described with reference to the accompanying drawings according to exemplary embodiments. In the drawings, unless otherwise noted, like reference numerals refer to like elements throughout, and thus, repeated descriptions thereof may be omitted.

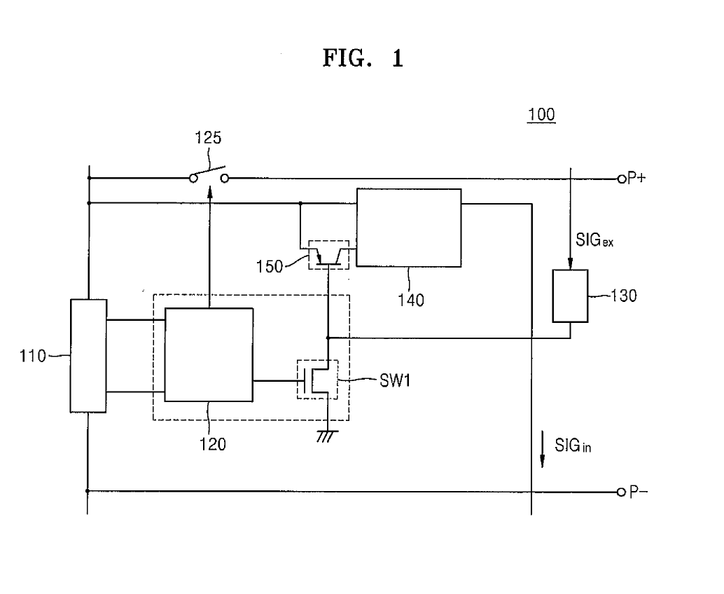

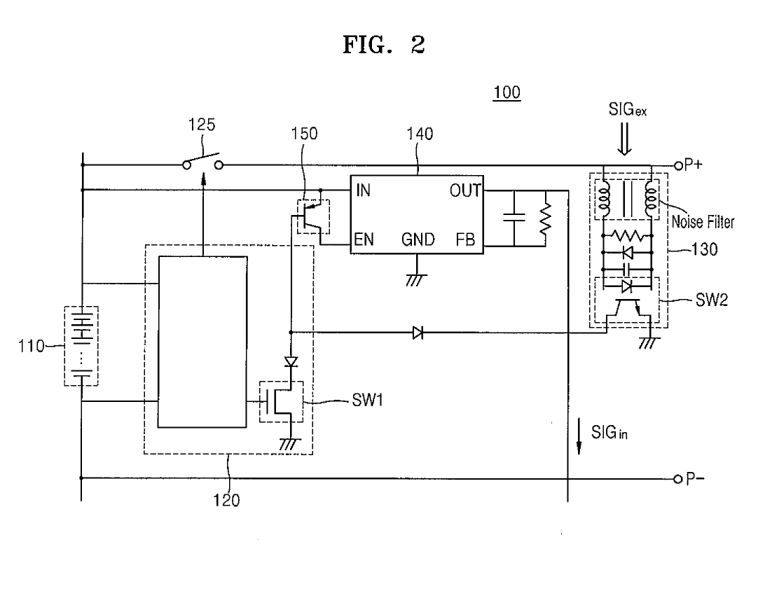

FIGS. 1 and 2 are schematic diagrams illustrating an overcharge protection apparatus 100 for a battery pack according to an exemplary embodiment.

Referring to FIG. 1, the overcharge protection apparatus 100 of the present exemplary embodiment may include a battery module 110, a first battery management unit (e.g., a first battery manager) 120, a second battery management unit (e.g., a second battery manager) 130, an overcharge control unit (e.g., an overcharge controller) 140, and a cutoff switch 150.

The battery module 110 may include one or more battery cells. In FIG. 1, the battery cells of the battery module 110 are not illustrated. However, the battery module 110 may include one or more battery cells. The number of the battery cells may vary according to a desired capacity of a system design.

The battery module 110 may be connected to an external power source through charge/discharge terminals P+ and P− to receive a charging current from the external power source, or may be connected to a load to supply a discharging current to the load. The battery modules 110 may be connected in series or in parallel to flexibly adjust an overall voltage or capacity.

The first battery management unit 120 may monitor whether the battery module 110 is overcharged or not and may include a first switch SW1. The first switch SW1 may be turned on if it is determined that the battery module 110 is overcharged. The first battery management unit 120 may be connected to a positive electrode and a negative electrode of the battery module 110 to measure the voltage and current of the battery module 110. The first battery management unit 120 may compare a measured voltage value with a preset voltage value to determine whether the battery module 110 is overcharged or not.

The first battery management unit 120 may be connected to positive and negative electrodes of each of the battery cells of the overcharge protection apparatus 100 to determine whether each battery cell is overcharged or not. When it is determined that any one of the battery cells of the battery module 110 is overcharged, the first switch SW1 may be turned on.

The overcharge protection apparatus 100 for a battery pack may include a switch 125 connecting the battery module 110 and the charge/discharge terminals P+ and P−. When it is determined that the battery module 110 is overcharged, the switch 125 may be turned off to interrupt a charging current flowing from an external power source to the battery module 110.

The second battery management unit 130 may include a second switch SW2 (refer to FIG. 2), and the second switch SW2 is turned on by an external cutoff signal SIGex input from the outside (e.g., outside of or external to the overcharge protection apparatus 100).

The cutoff switch 150 is connected to the first battery management unit 120 and the second battery management unit 130 and is turned on by the first switch SW1 or the second switch SW2. When the battery module 110 is overcharged, the cutoff switch 150 may be turned on by the first switch SW1 that is turned on by the first battery management unit 120. In addition, the cutoff switch 150 may be turned on by the second switch SW2 when the second switch SW2 is turned on by an external cutoff signal SIGex input from the outside of the overcharge protection apparatus 100. That is, the cutoff switch 150 is turned on by a signal generated in the overcharge protection apparatus 100 or a signal input from the outside of the overcharge protection apparatus 100.

The overcharge control unit 140 receives a control signal by the cutoff switch 150 and generates an internal cutoff signal SIGin in response to the control signal.

The overcharge protection apparatus 100 of the present exemplary embodiment will now be described in more detail with reference to FIG. 2. The same description as that given with reference to FIG. 1 may not be repeated.

The battery module 110 may include a plurality of battery cells, and as shown in FIG. 2, the positive and negative electrodes of the battery module 110 are connected to the first battery management unit 120, so that the first battery management unit 120 may measure the voltage and current of the battery module 110. In FIG. 2, only the positive and negative electrodes of the entire battery module 110 are shown as being connected to the first battery management unit 120. However, the present disclosure is not limited thereto, and the positive and negative electrodes of each of the battery cells of the battery module 110 may be connected to the first battery management unit 120, so that the first battery management unit 120 may measure the voltage and current of each of the battery cells.

That is, the first battery management unit 120 may measure the voltage and current of the entire battery module 110 or each of the battery cells of the battery module 110, and when it is determined that the battery module 110 or any one of the battery cells are overcharged, the first battery management unit 120 may turn on the first switch SW1. Then, the cutoff switch 150 is turned on when the first switch SW1 is turned on.

The overcharge control unit 140 receives an input signal from the battery module 110 through an input terminal IN and receives a control signal from the cutoff switch 150. When the first switch SW1 is turned on, the cutoff switch 150 is turned on and applies a control signal to the overcharge control unit 140 through an enable terminal EN.

When the overcharge control unit 140 receives the control signal from the cutoff switch 150 through the enable terminal EN, the overcharge control unit 140 outputs an internal cutoff signal SIGin through an output terminal OUT in response to the control signal. Then, the internal cutoff signal SIGin output through the output terminal OUT is fed back to the overcharge control unit 140 through a feedback terminal FB, and the overcharge control unit 140 determines whether or not a voltage level of the internal cutoff signal SIGin is equal or substantially equal to that of a preset voltage. When the voltage level of the internal cutoff signal SIGin is not equal or substantially equal to that of the preset voltage, the overcharge control unit 140 may output an internal cutoff signal SIGin having the same or substantially the same voltage level as that of the preset voltage.

The voltage level of the internal cutoff signal SIGin may be preset according to a desired system design, for example, the voltage level of the internal cutoff signal SIGin may be preset to be greater than the voltage level of the battery module 110. In addition, the voltage level of the internal cutoff signal SIGin may be set to be constant or substantially constant.

The second battery management unit 130 receives an external cutoff signal SIGex from an external device (e.g., external to the overcharge protection apparatus 100). Then, the second switch SW2 is turned on by the external cutoff signal SIGex input from the external device, and when the second switch SW2 is turned on, the cutoff switch 150 is turned on. When the cutoff switch 150 is turned on, a control signal is applied to the enable terminal EN of the overcharge control unit 140.

When the overcharge control unit 140 receives the control signal from the cutoff switch 150 through the enable terminal EN, the overcharge control unit 140 outputs an internal cutoff signal SIGin through the output terminal OUT in response to the control signal. Then, the internal cutoff signal SIGin output through the output terminal OUT is fed back to the overcharge control unit 140 through the feedback terminal FB, and the overcharge control unit 140 determines whether or not the voltage level of the internal cutoff signal SIGin is equal or substantially equal to that of the preset voltage. When the voltage level of the internal cutoff signal SIGin is not equal or substantially equal to that of the preset voltage, the overcharge control unit 140 may output an internal cutoff signal SIGin having the same or substantially the same voltage level as that of the preset voltage.

The second battery management unit 130 may include a noise filter. The noise filter removes noise from an external cutoff signal SIGex input from an external device, and then applies the external cutoff signal SIGex to the second switch SW2. Then, the second switch SW2 is turned on by the external cutoff signal SIGex from which the noise has been removed by the noise filter.

The second switch SW2 may be a non-contact switch. For example, as shown in FIG. 2, the second switch SW2 may include a photodiode and a phototransistor. When the external cutoff signal SIGex is applied to the photodiode after passing through the noise filter, the photodiode may radiate light, and the phototransistor may be turned on in response to the light radiated from the photodiode.

When the phototransistor is turned on, since a current path is formed between the cutoff switch 150 and ground, the cutoff switch 150 is turned on, and a control signal is applied to the enable terminal EN of the overcharge control unit 140 through the cutoff switch 150.

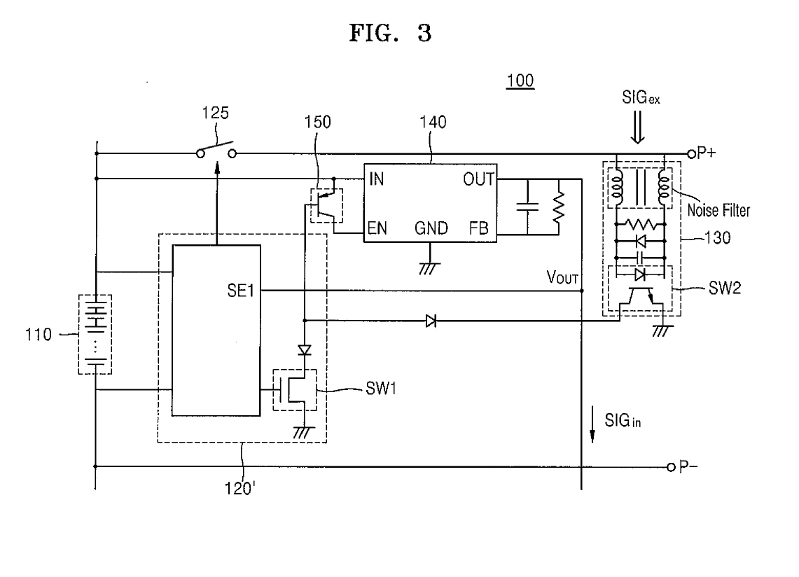

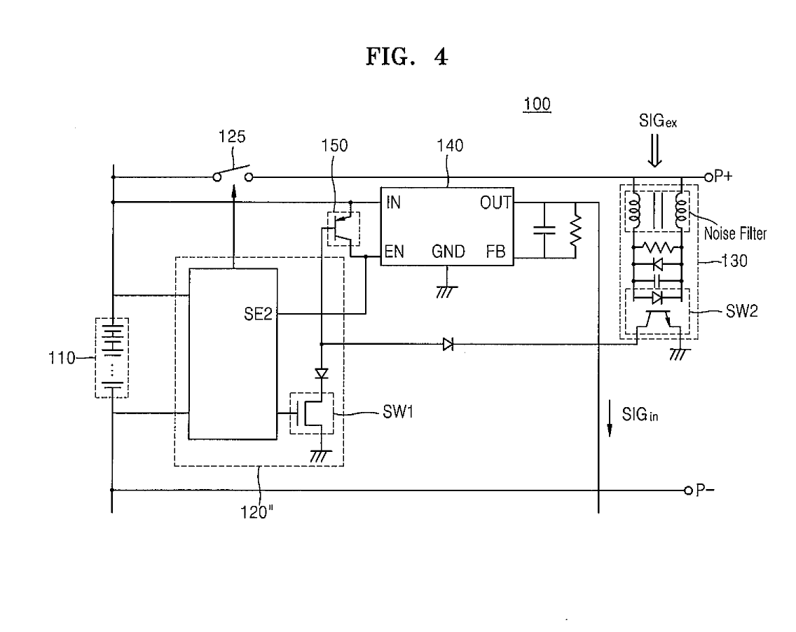

FIGS. 3 and 4 are schematic diagrams illustrating an overcharge protection apparatus 100 for a battery pack according to another exemplary embodiment.

Referring to FIG. 3, a first battery management unit (e.g., a first battery manager) 120′ may include a first sensing terminal SE1 to sense the voltage of an internal cutoff signal SIGin output through an output terminal OUT of an overcharge control unit (e.g., an overcharge controller) 140. The first battery management unit 120 may measure a voltage V_{OUT} of an output node through the first sensing terminal SE1, and when it is determined that an internal cutoff signal SIGin is output from the overcharge control unit 140, the first battery management unit 120 may turn off a switch 125 connecting a battery module 110 and external terminals P+ and P−.

Referring to FIG. 4, a first battery management unit (e.g., a first battery manager) 120″ may include a second sensing terminal SE2 to sense a control signal applied from a cutoff switch 150 to an enable terminal EN of the overcharge control unit 140. The first battery management unit 120 may sense a control signal through the second sensing terminal SE2, and when it is determined that a control signal is applied from the cutoff switch 150, the first battery management unit 120 may turn off the switch 125 connecting the battery module 110 and external terminals P+ and P−.

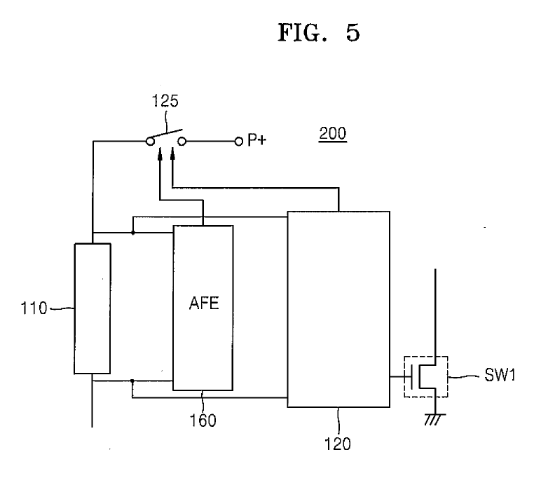

FIG. 5 is a schematic diagram illustrating an overcharge protection apparatus 200 for a battery pack according to another exemplary embodiment.

Referring to FIG. 5, the overcharge prevention apparatus 200 for a battery pack may further include an analog front end (AFE) 160 connected in parallel to a first battery management unit (e.g., a first battery manager) 120. In FIG. 5, only a battery module 110, the first battery management unit 120, and the AFE 160 are illustrated. However, the overcharge prevention apparatus 200 may include a second battery management unit (e.g., a second battery manager) 130, an overcharge control unit (e.g., an overcharge controller) 140, and a cutoff switch 150 as described above with reference to FIGS. 1 to 4. The elements not shown in FIG. 5 may function as described with reference to FIGS. 1 to 4. Further, the first battery management unit 120 shown in FIG. 5 may be the same or substantially the same as any one of the first battery management units 120, 120′, and 120″ as shown above with reference to FIGS. 1 to 4.

Like the first battery management unit 120, the AFE 160 may be connected to a positive electrode and a negative electrode of the battery module 110 to measure the voltage and current of the battery module 110. When it is determined that the battery module 110 is overcharged, a switch 125 connecting the battery module 110 and external terminals P+ and P− may be turned off to prevent the battery module 110 from being charged by an external power source (e.g., external to the overcharge protection apparatus 200).

In FIG. 5, the AFE 160 is shown as being connected to the positive and negative electrodes of the entire battery module 110. However, the present disclosure is not limited thereto, and the AFE 160 may be connected to positive and negative electrodes of each of battery cells of the battery module 110. Whether or not the battery module 110 or any one of the battery cells are overcharged may be monitored, and when it is determined that the battery module 110 or any one of the battery cells is overcharged, the switch 125 connecting the battery module 110 and the external terminals P+ and P− may be turned off.

A voltage level used as a reference voltage by the AFE 160 for determining whether or not the battery module 110 is overcharged may be less than a voltage level used as a reference voltage by the first battery management unit 120 for determining whether or not the battery module 110 is overcharged.

For example, when the AFE 160 uses a voltage level V₁ and the first battery management unit 120 uses a voltage level V₂, when the AFE 160 and the first battery management unit 120 determine whether the battery module 110 is overcharged, the voltage levels V₁ and V₂ may satisfy V₁<V₂.

The AFE 160 may monitor the voltage of the battery module 110, and when the voltage of the battery module 110 is greater than or equal to V₁, the AFE 160 may determine that the battery module 110 is overcharged.

Further, the first battery management unit 120 may determine that the battery module 110 is overcharged when the voltage of the battery module 110 is greater than or equal to V₂.

In this case, the first battery management unit 120 may function as a secondary overcharge protection unit (e.g., a secondary overcharge protector) for the battery module 110. That is, compared to the first battery management unit 120, the AFE 160 may protect the battery module 110 when the battery module 110 is overcharged to a relatively low voltage. However, if the AFE 160 does not properly perform its overcharge protection function, the first battery management unit 120 may function as a secondary overcharge protection unit to protect the battery module 110 from overcharge.

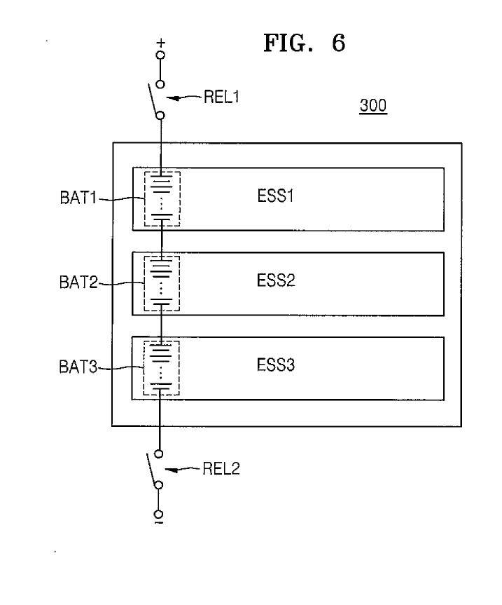

FIG. 6 is a schematic diagram illustrating an overcharge protection system 300 including a plurality of energy storage systems.

In the overcharge protection system 300 shown in FIG. 6, a first energy storage system ESS1, a second energy storage system ESS2, and a third energy storage system ESS3 are connected in series. The first to third energy storage systems ESS1 to ESS3 respectively include first to third battery modules BAT1, BAT2, and BAT3, each of the first to third battery modules BAT1, BAT2, and BAT3 including at least one battery cell.

The first to third battery modules BAT1 to BAT3 are connected in series. The first battery module BAT1 of the first energy storage system ESS1 is connected to an external positive (+) terminal, and the third battery module BAT3 of the third energy storage system ESS3 is connected to an external negative (−) terminal.

A first relay REL1 may be connected between the first energy storage system ESS1 and the external positive (+) terminal, or between the first battery module BAT1 and the external positive (+) terminal. A second relay REL2 may be connected between the third energy storage system ESS3 and the external negative (−) terminal, or between the third battery module BAT3 and the external negative (−) terminal.

When any one of the first to third battery modules BAT1 to BAT3 is overcharged, if a charging current or voltage is supplied to the external positive and negative terminals, the overcharged battery module may be damaged or the lifespan of the overcharged battery module may be decreased. Since this situation may affect the other non-overcharged battery modules, if any one of the first to third battery modules BAT1 to BAT3 is overcharged, it may be desirable to break (e.g., cut or disconnect) the series connection between the external positive and negative terminals and the first to third battery modules BAT1 to BAT3.

When any one of the first to third battery modules BAT1 to BAT3 is overcharged, the first and second relays REL1 and REL2 are turned off to cut the connection between the external positive and negative terminals and the first to third battery modules BAT1 to BAT3, and thus, damage caused by overcharging may not spread. Further, when only one of the first and second relays REL1 and REL2 is turned off, the connection between the positive and negative external terminals and the first to third battery modules BAT1 to BAT3 may be broken (e.g., cut or disconnected). Thus, in some embodiments, only one of the first and second relays REL1 and REL2 may be included and used.

In FIG. 6, three energy storage systems ESS1 to ESS3 are illustrated. However, it will be apparent to those of skill in the art that the number of energy storage systems connected in series may be varied according to a required voltage level or electricity capacity of a system.

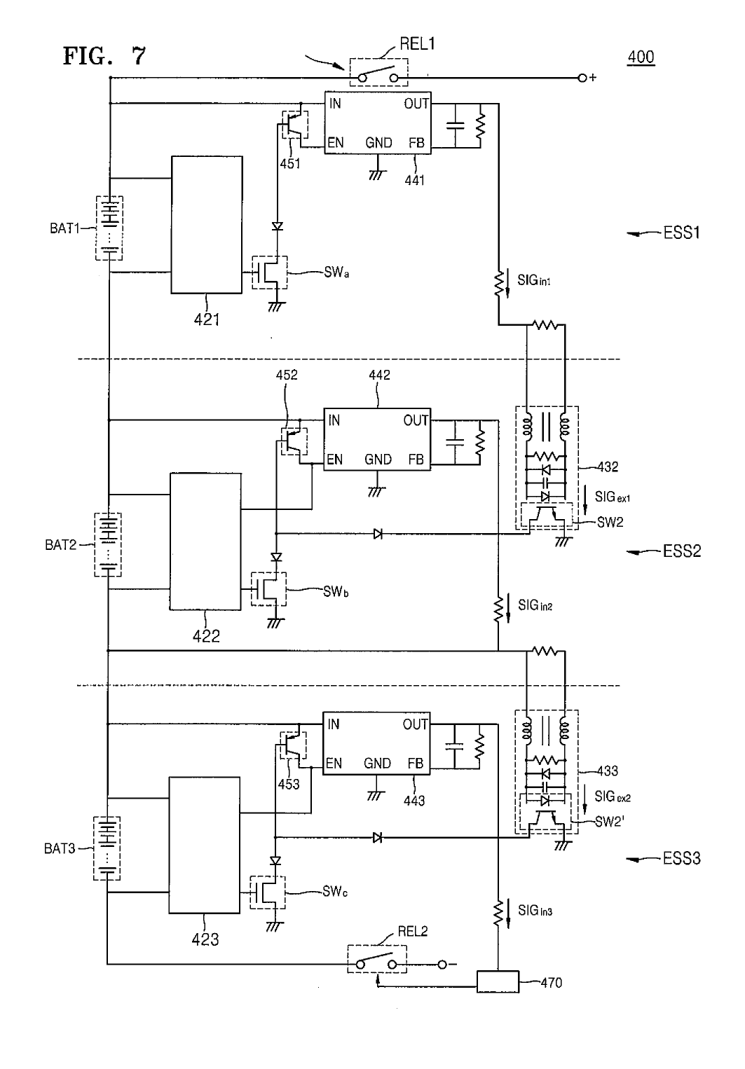

FIG. 7 is a schematic diagram illustrating an overcharge protection system 400 according to an exemplary embodiment.

Referring to FIG. 7, the overcharge protection system 400 of the present exemplary embodiment includes a first energy storage system ESS1, a second energy storage system ESS2, and a third energy storage system ESS3.

In FIG. 7, three energy storage systems ESS1 to ESS3 are shown. However, the number of energy storage systems included in the overcharge protection system 400 is not limited to three. It will be apparent to those of skill in the art that the number of energy storage systems may be varied according to a desired voltage level or capacity of a system.

As described with reference to FIGS. 1 to 5, each of the first to three energy storage systems ESS1 to ESS3 may include one or more elements having the same or substantially the same function as that of the overcharge protection apparatus 100 or 200 described above, and thus, the same description as given above may be omitted.

The first energy storage system ESS1 includes a battery module BAT1, a first battery management unit (e.g., a first battery manager) 421, an overcharge control unit (e.g., an overcharge controller) 441, and a cutoff switch 451. The battery module BAT1 includes at least one battery cell. The first battery management unit 421 monitors whether or not the battery module BAT1 is overcharged and includes a first switch SWa, which may be turned on when the battery module BAT1 is overcharged.

The cutoff switch 451 is connected to the first battery management unit 421 and is turned on by the first switch SWa. When the first battery management unit 421 determines that the battery module BAT1 is overcharged, the first battery management unit 421 turns on the first switch SWa. When the first switch SWa is turned on, the cutoff switch 451 is turned on.

The overcharge control unit 441 receives a control signal from the cutoff switch 451 and generates an internal cutoff signal SIGin₁ in response to the control signal. A voltage is applied from the battery module BAT1 to an input terminal IN of the overcharge control unit 441, and when the cutoff switch 451 is turned on, a control signal is applied from the cutoff switch 451 to an enable terminal EN of the overcharge control unit 441. When a control signal is applied to the enable terminal, the overcharge control unit 441 outputs an internal cutoff signal SIGin₁ through an output terminal OUT. In this case, the voltage level of the internal cutoff signal SIGin₁ may be set to be constant or substantially constant. For example, the voltage level of the internal cutoff signal SIGin₁ may be constant and greater than that of a voltage input from the battery module BAT1.

The second energy storage system ESS2 has the same or substantially the same structure as the first energy storage system ESS1, except that the second energy storage system ESS2 includes a second battery management unit (e.g., a second battery manager) 432. The second battery management unit 432 includes a second switch SW2, and the second switch SW2 is turned on by a cutoff signal input from a previous energy storage system. Here, the previous energy storage system refers to the first energy storage system ESS1. That is, the second battery management unit 432 receives an external cutoff signal SIGex₁ from the first energy storage system ESS1. The external cutoff signal SIGex₁ is a signal obtained by removing noises from an internal cutoff signal SIGin₁ output from the overcharge control unit 441 of the first energy storage system ESS1 by using a noise filter.

Referring to FIG. 7, the second battery management unit 432 of the second energy storage system ESS2 includes the noise filter and the second switch SW2 configured to be turned on by an external cutoff signal SIGex₁. The second switch may be a non-contact switch. For example, the second switch may include a photodiode and a phototransistor.

When an internal cutoff signal SIGin₁ output from the first energy storage system ESS1 passes through the noise filter and is applied to the second switch as an external cutoff signal SIGex₁, the photodiode may radiate light, and the phototransistor may be turned on in response to the light.

When the second switch is turned on in this manner, a cutoff switch 452 of the second energy storage system ESS2 is turned on, and a control signal is applied from the cutoff switch 452 to an enable terminal EN of an overcharge control unit (e.g., an overcharge controller) 442 of the second energy storage system ESS2. Then, the overcharge control unit 442 outputs an internal cutoff signal SIGin₂ through an output terminal OUT.

In this case, the voltage level of the internal cutoff signal SIGin₂ may be set to be constant or substantially constant. For example, the voltage level of the internal cutoff signal SIGin₂ may be constant and greater than that of a voltage input from a battery module BAT2.

A first battery management unit (e.g., a first battery manager) 422 of the second energy storage system ESS2 has the same or substantially the same function as that of the first battery management unit 421 of the first energy storage system ESS1 and protects the battery module BAT2 from overcharge.

Like the second energy storage system ESS2, the third energy storage system ESS3 includes a second battery management unit (e.g., a second battery manager) 433. The second battery management unit 433 has the same or substantially the same structure and function as those of the second battery management unit 432 of the second energy storage system ESS2.

That is, the second battery management unit 433 filters a cutoff signal SIGin₂ input from the second energy storage system ESS2 and applies the filtered cutoff signal SIGin₂ to a second switch as an external cutoff signal SIGex₂. When the second switch is turned on by the external cutoff signal SIGex₂, a cutoff switch 453 of the third energy storage system ESS3 is turned on. Then, an overcharge control unit (e.g., overcharge controller) 443 of the third energy storage system ESS3 outputs an internal cutoff signal SIGin₃ through an output terminal OUT.

The second battery management units 432 and 433 of the second and third energy storage systems ESS2 and ESS3 are configured to respectively receive internal cutoff signals SIGin₁ and SIGin₂ from previous energy storage systems. That is, the first and second energy storage systems ESS1 and ESS2 respectively apply external cutoff signals SIGex₁ and SIGex₂ to the second switches SW2 and SW2′.

When the second switches SW2 and SW2′ are turned on by the external cutoff signals SIGex₁ and SIGex₂, the cutoff switches 452 and 453 are turned on, and the overcharge control units 442 and 443 output internal cutoff signals SIGin₂ and SIGin₃ to next energy storage systems.

When a cutoff signal is output from each of the first to third energy storage systems ESS1 to ESS3, the voltage level of the cutoff signal is controlled to be constant by the overcharge control units 441 to 443. Therefore, even though cutoff signals passes through the energy storage systems ESS1 to ESS3 connected in series, the voltage level of the cutoff signals are not decreased. In addition, since each of the energy storage systems ESS1 to ESS3 includes a device for removing noises from a cutoff signal input thereto, even though noises are included in a cutoff signal while the cutoff signal is transmitted, the noises may be effectively removed.

In addition, the overcharge protection system 400 includes a cutoff signal receiving unit (e.g., a cutoff signal receiver) 470. Referring to FIG. 7, the cutoff signal receiving unit 470 receives an internal cutoff signal SIGin₃ from the third energy storage system ESS3. When the cutoff signal receiving unit 470 receives an internal cutoff signal, the cutoff signal receiving unit 470 determines that at least one of the battery modules BAT1 to BAT3 is overcharged. Then, the cutoff signal receiving unit 470 may turn off a main switch connecting the battery modules BAT1 to BAT3 and external charge terminals (+, −) to protect the battery modules BAT1 to BAT3 and the overcharge protection system 400 from overcharge damage. The main switch may include a first relay REL1 or a second relay REL2.

In FIG. 7, the first energy storage system ESS1 is illustrated as not including a second battery management unit. However, the first energy storage system ESS1 is not limited thereto. That is, the first energy storage system ESS1 may include a second battery management unit like the second and third energy storage systems ESS2 and ESS3.

In a system including a plurality of energy storage systems connected in series, the first one of the energy storage systems does not have a previous energy storage system transmitting an internal cutoff signal thereto. Therefore, the first energy storage system may not include a second battery management unit. However, if the system is expanded by adding additional energy storage systems, each of the energy storage systems of the system may include a corresponding one or more second battery management units.

For example, if an overcharge protection system includes four or more energy storage systems connected in series, each of the energy storage systems may include an overcharge protection unit such as those described with reference to FIGS. 1 to 5, and the overcharge protection system may include a cutoff signal receiving unit. If at least one of the energy storage systems is overcharged, the cutoff signal receiving unit turns off a main switch in response to a cutoff signal received from the last energy storage system to interrupt a current supplied to the overcharge protection system.

As described above, according to the one or more of the above exemplary embodiments, the overcharge protection apparatus for a battery pack and the overcharge protection system may protect battery packs or the entire system from overcharge, even though a primary overcharge protection unit operates abnormally.

In addition, although some of the energy storage systems connected in series are overcharged, the overcharge protection apparatus for a battery pack and the overcharge protection system may prevent or substantially prevent spreading of damage to the whole system.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims, and their equivalents.

What is claimed is:

1. An overcharge protection apparatus comprising:
a first battery manager configured to monitor whether or not a battery module comprising at least one battery cell is overcharged, the first battery manager comprising a first switch configured to be turned on when the battery module is overcharged;
a second battery manager comprising a second switch configured to be turned on by an external cutoff signal;
a cutoff switch connected to the first and second battery managers, and configured to be turned on by the first switch or the second switch; and
an overcharge controller configured to receive a control signal by the cutoff switch, and to generate an internal cutoff signal in response to the control signal.

2. The overcharge protection apparatus of claim 1, wherein the internal cutoff signal has a voltage level greater than a voltage level of the battery module.

3. The overcharge protection apparatus of claim 1, wherein the overcharge controller is configured to generate the internal cutoff signal, and to output the internal cutoff signal to the outside when the cutoff switch is turned on.

4. The overcharge protection apparatus of claim 1, further comprising:
an analog front end (AFE) connected in parallel with the first battery manager; and
a charge cutoff switch configured to cut off a charge path of the battery module,
wherein the first battery manager and the AFE are configured to turn off the charge cutoff switch when the first battery manager and the AFE determine that the battery module is overcharged.

5. The overcharge protection apparatus of claim 4, wherein a voltage level utilized as a reference voltage level by the AFE to determine whether or not the battery module is overcharged is less than a voltage level utilized as a reference voltage level by the first battery manager to determine whether or not the battery module is overcharged.

6. The overcharge protection apparatus of claim 1, wherein the second battery manager further comprises a noise filter configured to remove noise from the external cutoff signal, and
the second switch is further configured to be turned on by the external cutoff signal that passed through the noise filter.

7. The overcharge protection apparatus of claim 1, wherein the second switch comprises a non-contact switch.

8. The overcharge protection apparatus of claim 1, wherein the overcharge controller is configured to output the internal cutoff signal having a constant voltage level in response to the control signal.

9. The overcharge protection apparatus of claim 1, further comprising the battery module comprising the at least one battery cell.

10. An overcharge protection system comprising:
a plurality of energy storage systems connected in series, each of the energy storage systems comprising:
a battery module comprising at least one battery cell;
a first battery manager configured to monitor whether or not the battery module is overcharged, the first battery manager comprising a first switch configured to be turned on when the battery module is overcharged;
a second battery manager comprising a second switch configured to be turned on by an external cutoff signal input from a previous energy storage system;
a cutoff switch connected to the first and second battery managers, and configured to be turned on by the first switch or the second switch; and
an overcharge controller configured to receive a control signal by the cutoff switch, and to generate an internal cutoff signal in response to the control signal,
wherein the battery modules of the energy storage systems are connected in series.

11. The overcharge protection system of claim 10, wherein the internal cutoff signal has a voltage level greater than a voltage level of the control signal.

12. The overcharge protection system of claim 10, wherein the internal cutoff signal is output to a second battery manager of a next energy storage system.

13. The overcharge protection system of claim 10, further comprising:
an analog front end (AFE) connected in parallel with the first battery manager; and
a charge cutoff switch configured to cut off a charge path of the battery module,
wherein the first battery manager and the AFE are configured to turn off the charge cutoff switch when the first battery manager and the AFE determine that the battery module is overcharged.

14. The overcharge protection system of claim 10, wherein the second battery manager further comprises a noise filter configured to remove noise from the external cutoff signal, and
the second switch is configured to be turned on by the external cutoff signal that passed through the noise filter.

15. The overcharge protection system of claim 10, wherein the second switch comprises a non-contact switch.

16. The overcharge protection system of claim 10, wherein the overcharge controller is configured to output the internal cutoff signal having a constant voltage level in response to the control signal.

17. The overcharge protection system of claim 10, further comprising:
a cutoff signal receiver configured to receive an internal cutoff signal from a last energy storage system; and
a main switch configured to connect the battery modules to external charge terminals,
wherein the cutoff signal receiver is configured to turn off the main switch when the cutoff signal receiver receives the internal cutoff signal from the last energy storage system.
